(19) United States
(12) Patent Application Publication
(10) Pub. No.: US 2018/0275577 A1
(43) Pub. Date: Sep. 27, 2018

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Kazuhiro Nishiwaki, Mishima Shizuoka (JP)

(21) Appl. No.: 15/466,045

(22) Filed: Mar. 22, 2017

(51) Int. Cl. G03G 15/00; G03G 15/20

(52) U.S. Cl. CPC G03G 15/5045; G03G 15/5037; G03G 15/2003; G03G 2215/021; G03G 2215/00084; G03G 2215/00371; G03G 15/6529

(57) ABSTRACT

In accordance with an embodiment, an image forming apparatus comprises a housing, an image forming section, a temperature sensor, a determination section and a controller. The image forming section has a photoconductive drum and a charging roller for forming an image on a sheet which are arranged in the housing. The temperature sensor measures a temperature in the housing. The determination section determines whether or not the temperature meets a predetermined temperature. The controller carries out an image forming processing by controlling the image forming section if it is determined that a determination result by the determination section meets the predetermined temperature.

### FIELD

Embodiments described herein relate generally to an image forming apparatus and an image forming method.

### BACKGROUND

A resistance value of a conductive material such as a charging roller changes according to repeated bias applications and temperature. For instance the resistance value of the charging roller increases in a low temperature environment. As a result, the charging roller partially discharges at the time of discharge. Thus, an inflowing current to the surface of a photoconductive drum becomes inhomogeneous, and a defective image having white spots in an image area occurs.

As a measure of the defective image, there is a case in which a resistance detection sensor is loaded. The resistance detection sensor calculates the resistance value of the charging roller on the basis of a voltage value and a current value which are measured when a constant current and voltage flow to the charging roller. The occurrence of the defective image is suppressed by changing the bias application on the basis of the calculated resistance value of the charging roller.

However, if the resistance detection sensor is loaded, the cost is increased. Further, the change of high voltage output setting also corresponds to an increase cost of a transformer. Due to these defects, there is a case in which the resistance detection sensor cannot be loaded in a low-cost machine.

### DESCRIPTION OF THE DRAWINGS

FIG. 1 is an external view illustrating an example of an entire constitution of an image forming apparatus 100 according to a first embodiment;

FIG. 2 is a cross-sectional view illustrating an example of a constitution of a printer section 130 according to the first embodiment;

FIG. 3 is a block diagram illustrating an example of functional components of the image forming apparatus 100 according to the first embodiment;

FIG. 4 is a flowchart illustrating the flow of a processing for increasing a temperature in the image forming apparatus 100 according to the first embodiment;

FIG. 5 is a diagram illustrating a relationship of the temperature in the image forming apparatus 100 and a resistance value of a charging roller 133 according to the first embodiment;

FIG. 6 is a diagram illustrating a relationship of the number of sheets and the resistance value of the charging roller 133 according to the first embodiment;

FIG. 7 is a diagram illustrating a relationship of a white point level and the resistance value of the charging roller 133 according to the first embodiment;

FIG. 8 is a diagram illustrating the increase of a peripheral temperature of a photoconductive drum 132 with elapse of time according to the first embodiment;

FIG. 9 is a diagram illustrating a relationship of the temperature in the image forming apparatus 100 and the necessary temperature in the image forming apparatus 100 according to the first embodiment;

FIG. 10 is a block diagram illustrating an example of functional components of an image forming apparatus 100 according to a second embodiment; and

FIG. 11 is a flowchart illustrating the flow of a processing for increasing the temperature in the image forming apparatus 100 according to the second embodiment.

### DETAILED DESCRIPTION

In accordance with an embodiment, an image forming apparatus comprises a housing, an image forming section, a temperature sensor, a determination section and a controller. In the housing, devices constituting the image forming apparatus are housed. The image forming section has a photoconductive drum and a charging roller, for forming an image on a sheet which are arranged in the housing. The temperature sensor measures a temperature in the housing. The determination section determines whether or not the temperature meets a predetermined temperature. The controller carries out an image forming processing by controlling the image forming section if it is determined that a determination result by the determination section meets the predetermined temperature.

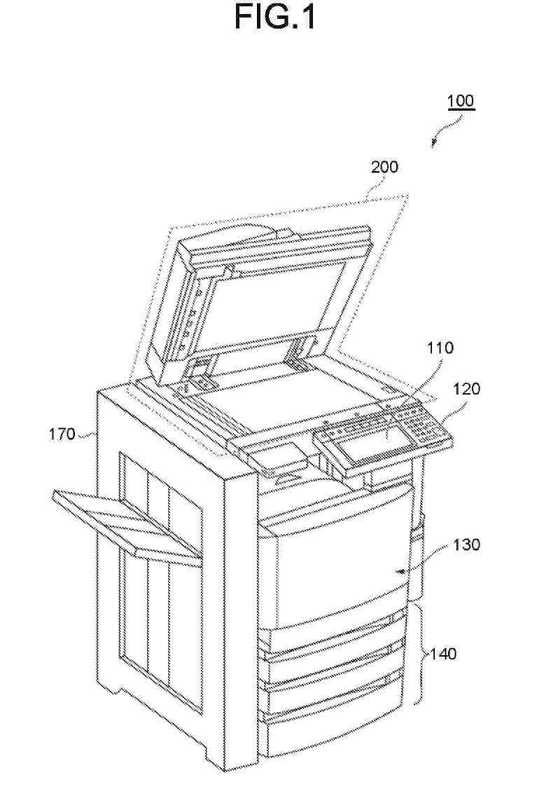

FIG. 1 is an external view illustrating an example of an entire constitution of the image forming apparatus 100 according to a first embodiment. The image forming apparatus 100 is, for example, an MFP (Multifunction Peripheral). The image forming apparatus 100 is equipped with a display 110, a control panel 120, a printer section 130, a sheet housing section 140 and an image reading section 200. Further, the printer section 130 of the image forming apparatus 100 may be a device for fixing a toner image.

The image forming apparatus 100 forms an image on a sheet using a developing agent such as toner. The sheet is, for example, a paper or a label paper. The sheet may be any object as long as the image forming apparatus 100 can form an image on its surface.

The display 110 is an image display device such as a liquid crystal display and an organic EL (Electro Luminescence) display. The display 110 displays various kinds of information relating to the image forming apparatus 100.

The control panel 120 includes a plurality of buttons. The control panel 120 receives operations of a user. The control panel 120 outputs a signal corresponding to an operation carried out by a user to a controller of the image forming apparatus 100. Further, the display 110 and the control panel 120 may be integrated into a single touch panel.

The printer section 130 carries out an image forming processing on a sheet on the basis of image information generated by the image reading section 200 or image information received via a communication path. The printer section 130 carries out the image forming processing through, for example, the following processing. An image forming section 180 of the printer section 130 forms an electrostatic latent image on the photoconductive drum on the basis of the image information. The image forming section 180 of the printer section 130 enables a developing agent to adhere to the electrostatic latent image to form a visible image. As a concrete example of the developing agent, toner is exemplified. The image forming section 180 of the printer section 130 transfers the visible image on a sheet. A fixing section of the printer section 130 fixes the visible image on the sheet by heating and pressuring the sheet. Further, the sheet on which an image is formed may be a sheet housed in the sheet housing section 140 or a manually fed sheet.

The sheet housing section 140 houses the sheet used for image formation in the printer section 130.

A housing 170 is a container for storing devices constituting the image forming apparatus 100. The inside of the housing 170 is a hollow. In the housing 170, for example, the printer section 130 and the sheet housing section 140 are stored.

The image reading section 200 reads the image information of a read object as intensity of light. The image reading section 200 records the read image information. The recorded image information may be sent to another information processing apparatus via a network. The recorded image information may be used for the image formation on the sheet through the printer section 130.

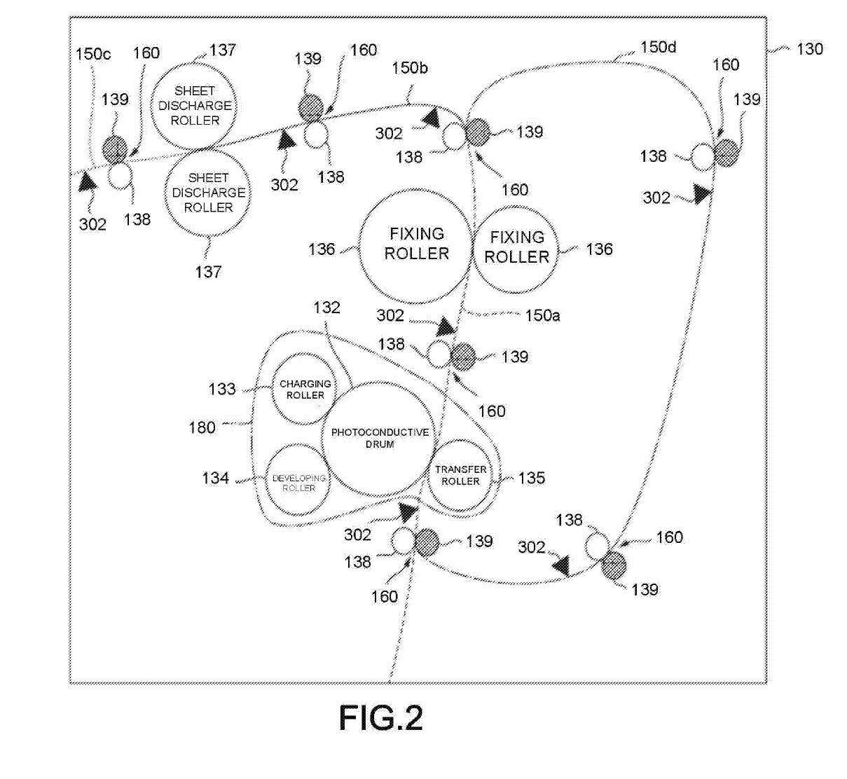

FIG. 2 is a cross-sectional view illustrating an example of a constitution of the printer section 130 according to the first embodiment. A charging roller 133, a developing roller 134, and a transfer roller 135 are arranged closely on the photoconductive drum 132. The charging roller 133 charges a surface of the photoconductive drum 132. The developing roller 134 enables a developing material to adhere to the photoconductive drum 132. The transfer roller 135 transfers the developing material adhering to the photoconductive drum 132 to the sheet. A fixing roller 136 includes a heater. The fixing roller 136 which is heated to a predetermined temperature by the heater fixes the developing material adhering to the sheet on the sheet. A sheet discharge roller 137 discharges the sheet on which the developing material is fixed from the image forming apparatus 100. The heater is one form of a fixing device.

The printer section 130 includes conveyance paths 150a-150d. The conveyance paths 150a-150d are paths conveying the sheet in the printer section 130. Hereinafter, the sheet housing section 140 side is described as the upstream side, and a sheet discharge tray side is described as the downstream side.

In the conveyance paths 150a-150d, a plurality of conveyance rollers 138, a plurality of platen rollers 139 and a plurality of position sensors 302 are arranged.

The driven conveyance roller 138 conveys the sheet. The platen roller 139 is arranged opposite to the conveyance roller 138. The platen roller 139 presses the sheet in order to convey the sheet properly. The sheet can be conveyed along the conveyance paths 150a-150d according to the conveyance roller 138 and the platen roller 139.

The position sensor 302 detects whether there is a sheet or not. According to the position sensor 302, the position of the sheet existing in the printer section 130 is detected.

One end of the conveyance path 150a is connected to the sheet housing section 140. The other end of the conveyance path 150a is connected to the conveyance path 150b and the conveyance path 150d. In a case in which the sheet is discharged, the conveyance path 150a conveys the sheet to the conveyance path 150b. On the contrary, in a case in which the sheet is not discharged, the conveyance path 150a conveys the sheet to the conveyance path 150d. The case in which the sheet cannot be discharged refers to, for example, a case in which the sheet heated by the fixing device is heated in the image forming apparatus 100.

One end of the conveyance path 150b is connected to the conveyance path 150a. The other end of the conveyance path 150b is connected to the conveyance path 150c. The conveyance path 150b conveys the sheet to the conveyance path 150c.

One end of the conveyance path 150c is connected to the conveyance path 150b. The other end of the conveyance path 150c is connected to the discharge tray. The conveyance path 150c conveys the sheet which is conveyed from the conveyance path 150b to the discharge tray.

One end of the conveyance path 150d is connected to the conveyance path 150a which is located at the downstream side of the fixing roller 136. The other end of the conveyance path 150d is connected to the conveyance path 150a which is located at the upstream side of the photoconductive drum 132. The conveyance path 150d conveys the sheet to the conveyance path 150a which is located at the upstream side of the photoconductive drum 132.

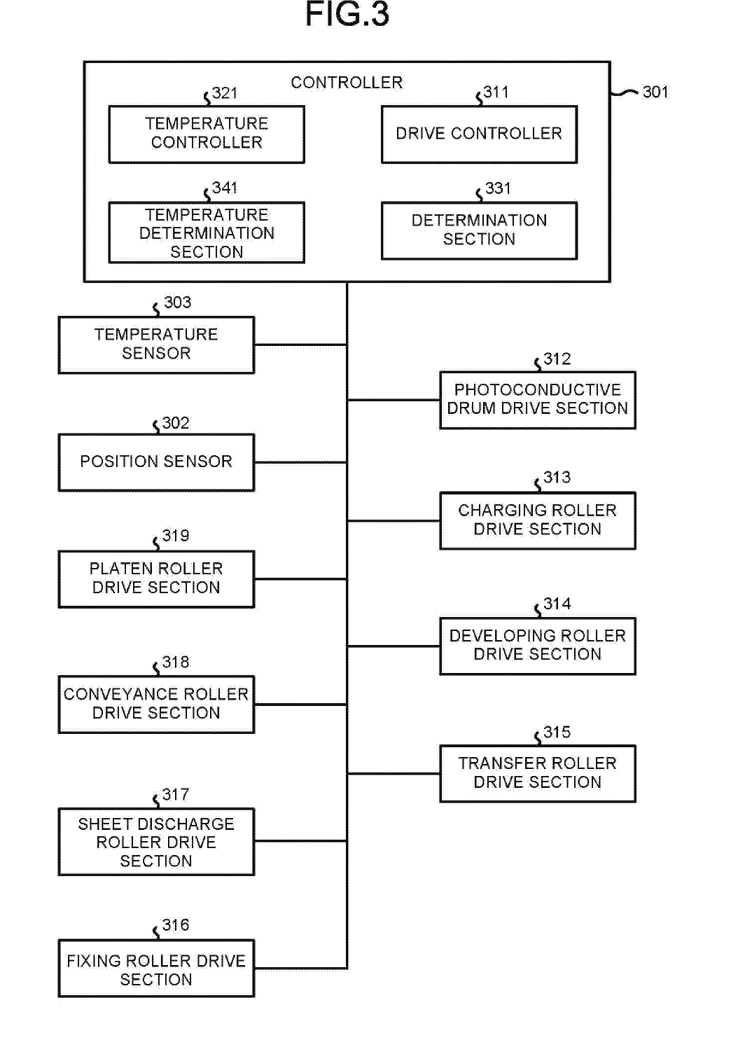

FIG. 3 is a block diagram illustrating an example of functional components of the image forming apparatus 100 according to the first embodiment. The controller 301 controls operations of each section of the image forming apparatus 100. The controller 301 functions as a drive controller 311, a temperature controller 321, a determination section 331 and a temperature determination section 341 by carrying out an image forming program. The controller 301 enables the printer section 130 to carry out the image forming processing. The controller 301 discharges the sheet on which the image is formed to the sheet discharge roller 137. The controller 301 comprises devices including, for example, a CPU (Central Processing Unit) and a RAM (Random Access Memory).

The drive controller 311 controls drive of each roller that constitutes the printer section 130. A photoconductive drum drive section 312 drives the photoconductive drum 132 according to the operation instruction of the drive controller 311. The photoconductive drum drive section 312 applies, for example, the driving force which is generated by the rotation of the motor to the photoconductive drum 132. A charging roller drive section 313 drives the charging roller 133 according to the operation instruction of the drive controller 311. The charging roller drive section 313 applies, for example, the driving force which is generated by the rotation of the motor to the charging roller 133. A developing roller drive section 314 drives the developing roller 134 according to the operation instruction of the drive controller 311. The developing roller drive section 314 applies, for example, the driving force which is generated by the rotation of the motor to the developing roller 134. A transfer roller drive section 315 drives the transfer roller 135 according to the operation instruction of the drive controller 311. The transfer roller drive section 315 applies, for example, the driving force which is generated by the rotation of the motor to the transfer roller 135. A fixing roller drive section 316 drives the fixing roller 136 according to the operation instruction of the drive controller 311. The fixing roller drive section 316 applies, for example, the driving force which is generated by the rotation of the motor to the fixing roller 136. A sheet discharge roller drive section 317 drives the sheet discharge roller 137 according to the operation instruction of the drive controller 311. The sheet discharge roller drive section 317 applies, for example, the driving force which is generated by the rotation of the motor to the sheet discharge roller 137. A conveyance roller drive section 318 drives the conveyance roller 138 according to the operation instruction of the drive controller 311. The conveyance roller drive section 318 applies, for example, the driving force which is generated by the rotation of the motor to the conveyance roller 138. A platen roller drive section 319 drives the platen roller 139 according to the operation instruction of the drive controller 311. The platen roller drive section 319 applies, for example, the driving force which is generated by the rotation of the motor to the platen roller 139. Further, one drive section may drive a plurality of rollers.

The temperature controller 321 carries out sheet passing control for the sheet. The sheet passing control conveys the sheet into the housing 170 until the temperature measured by the temperature sensor 303 is equal to or greater than a predetermined temperature. The temperature controller 321 conveys the sheet by controlling the conveyance section 160 which is equipped with the conveyance roller 138 and the conveyance roller drive section 318 driving the conveyance roller. The sheet passing control conveys the sheet to the conveyance path 150d from the conveyance path 150a, and then, conveys the sheet to the conveyance path 150a positioned at the upstream side of the photoconductive drum 132. At this time, the temperature in the image forming apparatus 100 increases, and a resistance value of the charging roller 133 decreases as the sheet is heated by the heated fixing device. The sheet passing control is carried out if the determination section 331 determines that the temperature measured by the temperature sensor 303 is not equal to or greater than the predetermined temperature. The sheet passing control is repeated until the temperature in the image forming apparatus 100 is equal to or greater than the predetermined temperature.

The temperature controller 321 carries out the sheet passing control according to predetermined setting. The predetermined settings are conditions, for example, a charging bias is −500V, a developing bias is −350V, a transfer bias is off, a peeling bias is −3 μA, exposure is off, and exposure of a laser and an LED (Light Emitting Diode) is not emitted. Further, conditions in a case of AC (Alternating Current) superposition are conditions that frequency is 1.0 KHz, Vp-p is 1.5 kV, and DC (Direct Current) is −500V. As long as each parameter value of the predetermined setting refers to the condition that the developing material does not adhere to the sheet may change.

The determination section 331 determines whether or not the temperature in the image forming apparatus 100 meets a predetermined condition. The predetermined condition may be a condition, for example, the temperature in the image forming apparatus 100 is greater than a necessary temperature in the image forming apparatus 100. Further, the predetermined condition may be a condition, for example, the temperature in the image forming apparatus 100 is equal to or greater than the necessary temperature in the image forming apparatus 100.

The temperature determination section 341 calculates the necessary temperature in the image forming apparatus 100. The necessary temperature in the image forming apparatus 100 is calculated on the basis of the temperature detected by the temperature sensor 303, Vpp (kV) of the alternating current bias that applies a voltage to the photoconductive drum 132 and the number of the sheets on which the image is formed.

The temperature sensor 303 measures the temperature in the housing 170 of the image forming apparatus 100. The temperature sensor 303 measures, for example, the surface temperature of the charging roller 133. It is desired that the temperature sensor 303 especially measures the surface temperature of the photoconductive drum 132. The temperature sensor 303 is, for example, a non-contact thermometer. The temperature sensor 303 carries out temperature measurement when the sheet passing control is carried out for a predetermined number of times and when an image forming instruction is received. The predetermined number of times may be, for example, an odd number of times, or an even number of times.

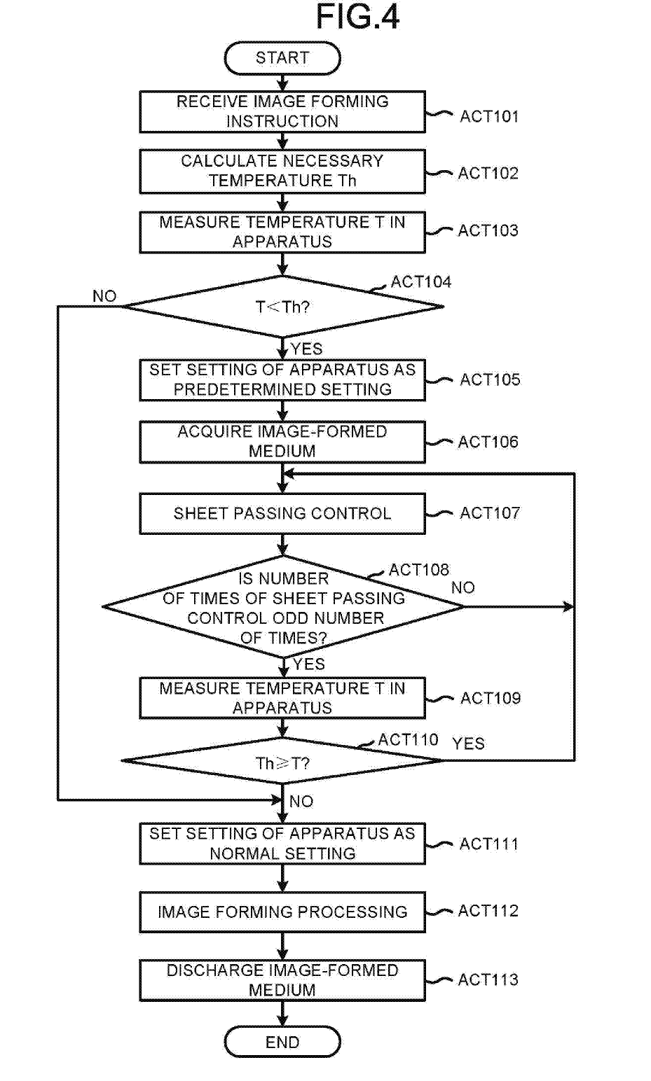

FIG. 4 is a flowchart illustrating the flow of a processing for increasing the temperature in the image forming apparatus 100 according to the first embodiment. The image forming apparatus 100 receives the image forming instruction (ACT 101). The temperature determination section 341 calculates a necessary temperature Th in the image forming apparatus 100 (ACT 102). The temperature sensor 303 measures a temperature T in the image forming apparatus 100 (ACT 103).

The determination section 331 determines whether or not the temperature Th is higher than the temperature T (ACT 104). If the temperature Th is not higher than the temperature T (NO in ACT 104), a processing in ACT 111 is carried out. If the temperature Th is higher than the temperature T (YES in ACT 104), the temperature controller 321 sets the setting of each section of the image forming apparatus as predetermined setting (ACT 105). The predetermined setting is setting for carrying out the sheet passing control. The controller 301 acquires a sheet from the sheet housing section 140 (ACT 106). The temperature controller 321 carries out the sheet passing control for the sheet (ACT 107). The temperature sensor 303 determines whether or not the number of times of the sheet passing control is an odd number of times (ACT 108). If the number of times of the sheet passing control is not the odd number of times (NO in ACT 108), returning to the processing in ACT 107, the temperature controller 321 carries out the sheet passing control for the sheet. If the number of times of the sheet passing control is the odd number of times (YES in ACT 108), the temperature sensor 303 measures the temperature T in the image forming apparatus 100 (ACT 109).

The determination section 331 determines whether or not the temperature Th is equal to or greater than the temperature T (ACT 110). If the temperature Th is equal to or greater than the temperature T (YES in ACT 110), returning to the processing in ACT 107, the temperature controller 321 carries out the sheet passing control for the sheet. If the temperature Th is not equal to or greater than the temperature T (NO in ACT 110), the controller 301 sets the setting of each section of the image forming apparatus 100 as the setting for carrying out the image forming processing (ACT 111). The controller 301 carries out the image forming processing for the sheet (ACT 112). The controller 301 discharges the sheet to which the image forming processing is carried out (ACT 113).

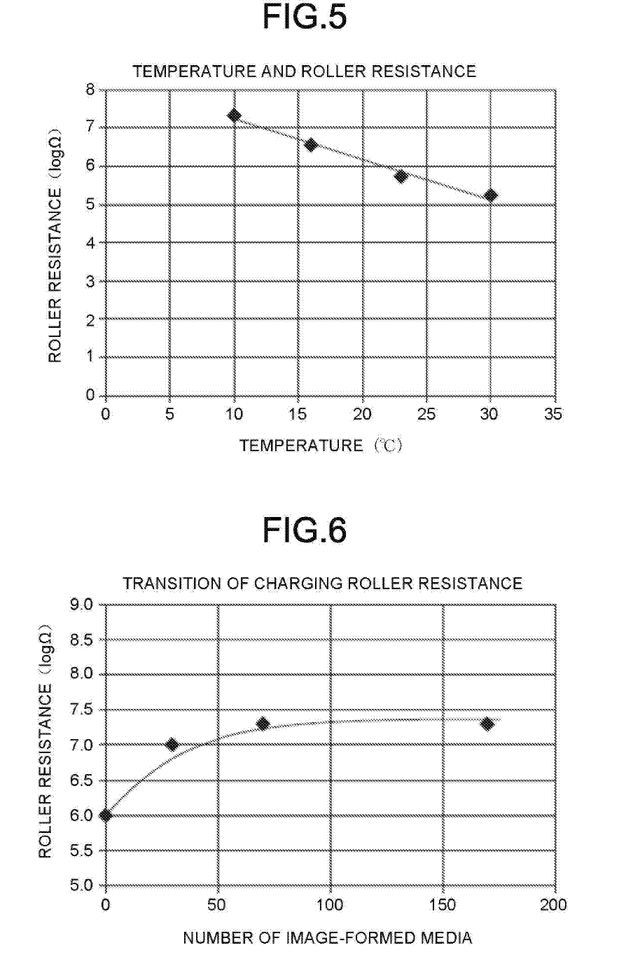

FIG. 5 is a diagram illustrating the relationship of the temperature in the image forming apparatus 100 and the resistance value of the charging roller 133 according to the first embodiment. From FIG. 5, it is known that the higher the temperature in the image forming apparatus 100 becomes, the lower the resistance value of the charging roller 133 becomes.

FIG. 6 is a diagram illustrating the relationship of the number of sheets and the resistance value of the charging roller 133 according to the first embodiment. From FIG. 6, it is known that if the number of the sheets is increased, the resistance value of the charging roller 133 rises. It is known that the resistance value of the charging roller 133 is saturated if the number of the sheets is about 100.

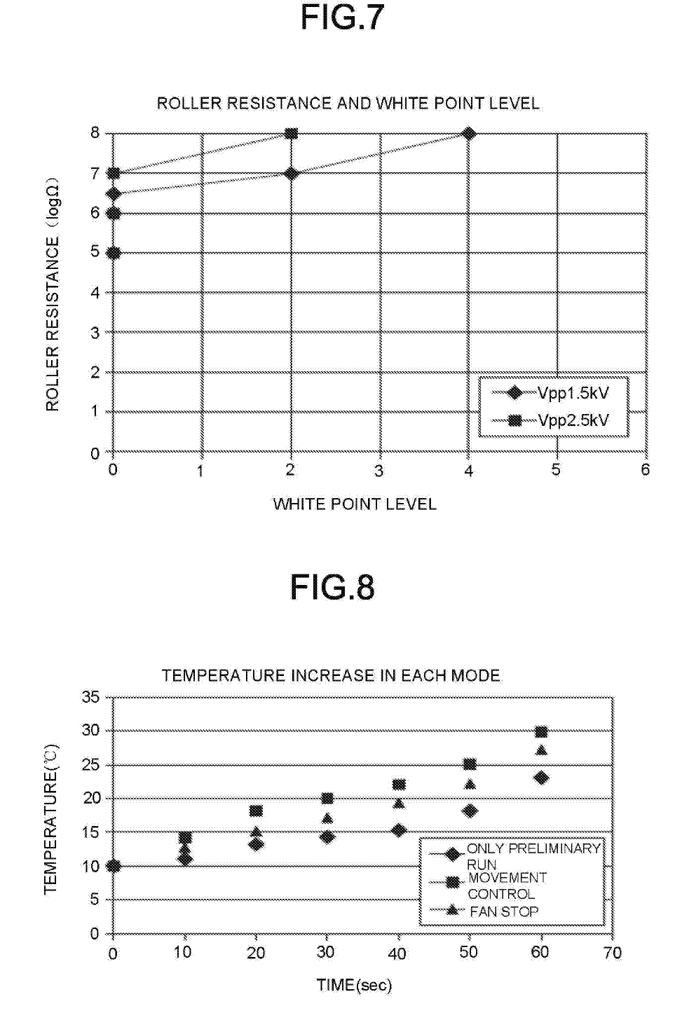

FIG. 7 is a diagram illustrating the relationship of the white point level and the resistance value of the charging roller 133 according to the first embodiment. The white point level shows the number of the white point of the image formed on the sheet. The higher the white point level is, the more the white points are. From FIG. 7, it is known that the higher the resistance value of the charging roller is, the higher the white point level is. Further, in a case in which the resistance value of the charging roller 133 is the same, the white point level of the lower alternating current bias (Vpp) is higher. Thus, it is known that the lower the alternating current bias (Vpp) is, the higher the white point level is.

FIG. 8 is a diagram illustrating the increase of the peripheral temperature of the photoconductive drum 132 with elapse of time according to the first embodiment. In FIG. 8, the temperature is measured in the state of each of preliminary run, the sheet passing control and fan stop. The sheet passing control for the sheet is not carried out in the preliminary run. The sheet passing control indicates the increase of the temperature in a case in which the sheet passing control of the sheet is carried out. The fan stop displays the increase of the temperature in a state in which the fan for cooling down the roller is stopped. From FIG. 8, it is known that the temperature in the image forming apparatus 100 is increased at the highest speed as the sheet passing control is carried out.

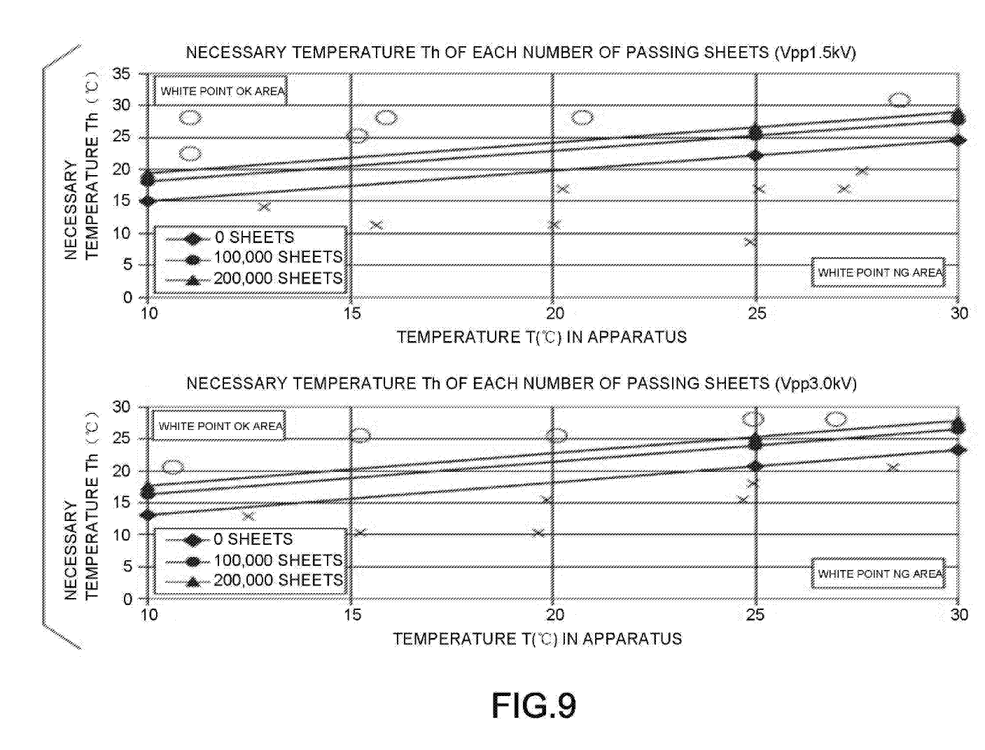

FIG. 9 is a diagram illustrating the relationship of the temperature in the image forming apparatus 100 and the necessary temperature in the image forming apparatus 100 according to the first embodiment. It is known from FIG. 9 that the necessary temperature becomes higher if the number of the sheets is increased. Further, it is known that the necessary temperature is decreased if the alternating current bias becomes higher.

The image forming apparatus 100 constituted in this way can increase the temperature more efficiently, compared with the temperature increase in the preliminary run or fan stop. Further, occurrence of defective images can be suppressed without costing more as it is not necessary to vary the voltage. The temperature controller 321 can maintain the temperature at which the resistance value of the charging roller 133 is not increased even though the temperature T falls below the temperature Th by carrying out the sheet passing control. Therefore, it becomes unnecessary to carry out the sheet passing control at the time the image forming instruction is received from the user. Thus, the time until the end of the image forming processing is shortened.

Further, the sheet used in the sheet passing control is discharged as it is without being subjected to the image forming processing. Thus, the user can reuse the sheet.

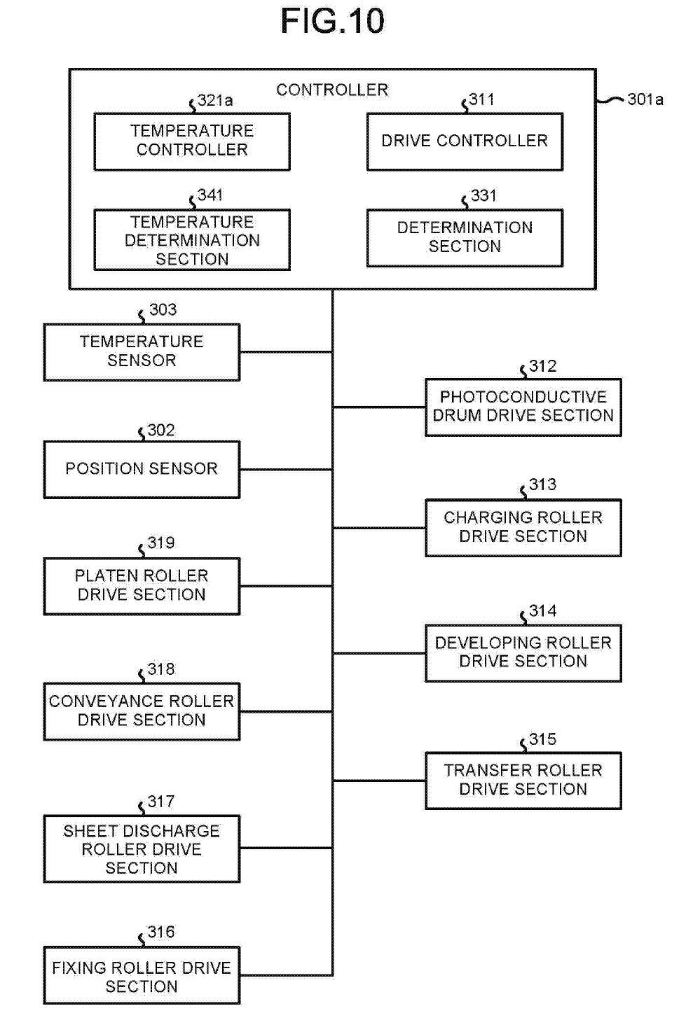

FIG. 10 is a block diagram illustrating an example of functional components of an image forming apparatus 100 according to a second embodiment. The difference between the image forming apparatus 100 in the second embodiment and the image forming apparatus 100 in the first embodiment is that the image forming apparatus 100 in the second embodiment is equipped with a controller 301a instead of the controller 301; however, other components of the image forming apparatus 100 in the second embodiment and the image forming apparatus 100 in the first embodiment are the same. Hereinafter, the difference from the first embodiment is described.

The controller 301a controls the operation of each section of the image forming apparatus 100. The controller 301a functions as the drive controller 311, a temperature controller 321a, the determination section 331 and the temperature determination section 341 by carrying out the image forming program. The controller 301a enables the printer section 130 to carry out the image forming processing. The controller 301a discharges the sheet on which an image is formed to the sheet discharge roller 137. The controller 301a comprises devices including, for example, the CPU (Central Processing Unit) and the RAM (Random Access Memory).

The temperature controller 321a carries out the sheet passing control for the sheet. If the determination section 331 determines that the temperature measured by the temperature sensor 303 is not equal to or greater than the predetermined temperature, the sheet passing control is carried out. The sheet passing control is repeated until the temperature in the image forming apparatus 100 is equal to or greater than the predetermined temperature. The temperature controller 321a sets the temperature of the fixing device to a temperature higher than a fixing temperature of the developing material which is fixed on the sheet when carrying out the sheet passing control. The temperature higher than the fixing temperature may be, for example, 160-180 centigrade degrees or more in a case in which the normal temperature at which the toner is fixed on the sheet is 150 centigrade degrees. The temperature controller 321a carries out the sheet passing control according to predetermined setting. The predetermined setting is the same setting as the setting when the temperature controller 321 carries out the sheet passing control.

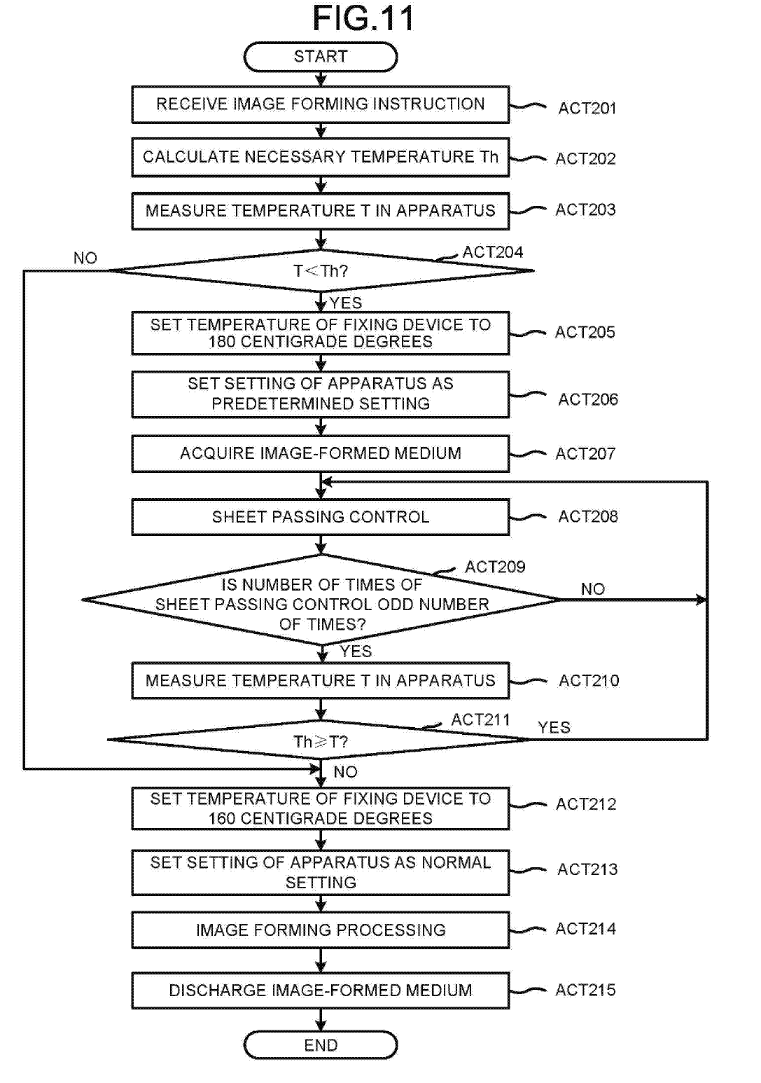

FIG. 11 is a flowchart illustrating the flow of a processing for increasing the temperature in the image forming apparatus 100 according to the second embodiment. The image forming apparatus 100 receives an image forming instruction (ACT 201). The temperature determination section 341 calculates a necessary temperature Th in the image forming apparatus 100 (ACT 202). The temperature sensor 303 measures a temperature T in the image forming apparatus 100 (ACT 203).

The determination section 331 determines whether or not the temperature Th is higher than the temperature T (ACT 204). If the temperature Th is not higher than the temperature T (NO in ACT 204), a processing in ACT 212 is carried out. If the temperature Th is higher than the temperature T (YES in ACT 204), the temperature controller 321a sets the temperature of the fixing device to 180 centigrade degrees (ACT 205). The temperature controller 321a sets the setting of each section of the image forming apparatus 100 to predetermined setting (ACT 206). The predetermined setting is a condition for carrying out the sheet passing control. The controller 301 acquires a sheet from the sheet housing section 140 (ACT 207). The temperature controller 321a carries out the sheet passing control for the sheet (ACT 208). The temperature sensor 303 determines whether or not the number of times of the sheet passing control is an odd number of times (ACT 209). If the number of times of the sheet passing control is not the odd number of times (ACT 209), returning to the processing in ACT 208, the temperature controller 321a carries out the sheet passing control for the sheet. If the number of times of the sheet passing control is the odd number of times (YES in ACT 209), the temperature sensor 303 measures the temperature T in the image forming apparatus 100 (ACT 210).

The determination section 331 determines whether or not the temperature Th is equal to or greater than the temperature T (ACT 211). If the temperature Th is equal to or greater than the temperature T (YES in ACT 211), returning to the processing in ACT 208, the temperature controller 321a carries out the sheet passing control for the sheet. If the temperature Th is not equal to or greater than the temperature T (NO in ACT 211), the temperature controller 321a sets the temperature of the fixing device to 160 centigrade degrees (ACT 212). The controller 301 sets the setting of each section of the image forming apparatus 100 to setting for carrying out the image forming processing (ACT 213). The controller 301 carries out the image forming processing for the sheet (ACT 214). The controller 301 discharges the sheet to which the image forming processing is carried out (ACT 215).

In the image forming apparatus 100 constituted in this way, the temperature of the fixing device becomes greater than the fixing temperature of the developing material. In this way, the sheet that is heated to a greater temperature than usual is moved at the time of the sheet passing control. Thus, the temperature in the image forming apparatus 100 can be increased in a shorter time.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
a housing;
an image forming section comprising a photoconductive drum and a charging roller for forming an image on a sheet which are arranged in the housing;
a temperature sensor configured to measure a temperature in the housing;
a determination section configured to determine whether or not the temperature meets a predetermined temperature; and
a controller configured to carry out an image forming processing by controlling every operation of the image forming section if it is determined that a determination result by the determination section meets the predetermined temperature.

2. The image forming apparatus according to claim 1, further comprising:
a temperature determination section configured to determine the predetermined temperature on a basis of the temperature in the image forming apparatus detected by the temperature sensor, a voltage of an alternating current bias that applies the voltage to a surface of the photoconductive drum, and a number of sheets on which an image is formed.

3. The image forming apparatus according to claim 1, further comprising:
a conveyance section comprising a conveyance roller that conveys the sheet and a conveyance roller drive section that drives the conveyance roller; and
a temperature control section configured to control the temperature in the housing to the predetermined temperature by carrying out sheet passing control that controls the conveyance section to enable the sheet heated by a fixing device to pass through a conveyance path if the determination section determines that the temperature in the housing does not meet the predetermined temperature.

4. The image forming apparatus according to claim 3, wherein
in a case in which the temperature controller controls the temperature to the predetermined temperature, a temperature of the fixing device becomes a higher temperature than a fixing temperature of a developing material fixed on the sheet.

5. The image forming apparatus according to claim 3, wherein
if the temperature controller carries out the sheet passing control for a predetermined number of times, the determination section is further configured to determine whether or not the temperature in the housing meets the predetermined temperature, if the determination result meets the predetermined temperature, the temperature controller carries out the sheet passing control for the sheet, and if the determination result does not meet the predetermined temperature, the controller carries out the image forming processing.

6. The image forming apparatus according to claim 3, wherein
if the temperature in the image forming apparatus falls below the predetermined temperature, the temperature controller carries out the sheet passing control.

7. The image forming apparatus according to claim 3, wherein
the sheet in the sheet passing control is discharged without being subjected to the image forming processing.

8. The image forming apparatus according to claim 1, wherein
the temperature sensor measures a temperature of the surface of the photoconductive drum as the temperature in the housing.

9. The image forming apparatus according to claim 1, wherein
the temperature sensor measures a temperature of a surface of the charging roller as the temperature in the housing.

10. The image forming apparatus according to claim 1, wherein
the temperature sensor is a non-contact thermometer.

11. An image forming method, comprising:
measuring a temperature in a housing of an image forming apparatus; forming an image on a sheet with a photoconductive drum and a charging roller which are arranged in the housing;
determining whether or not the temperature meets a predetermined temperature; and
controlling every operation of forming the image if it is determined that a determination result meets the predetermined temperature.

12. The image forming method according to claim 11, further comprising:
determining the predetermined temperature on a basis of the temperature in the image forming apparatus detected, a voltage of an alternating current bias that applies the voltage to a surface of the photoconductive drum, and a number of sheets on which an image is formed.

13. The image forming method according to claim 11, further comprising:
a conveyance section comprising a conveyance roller that conveys the sheet and a conveyance roller drive section that drives the conveyance roller; and
controlling the temperature in the housing to the predetermined temperature by carrying out the sheet passing control that controls a conveyance section to enable the sheet heated by a fixing device to pass through a conveyance path if the temperature in the housing does not meet the predetermined temperature.

14. The image forming method according to claim 13, further comprising:
controlling the temperature to the predetermined temperature when a temperature of the fixing device becomes a higher temperature than a fixing temperature of a developing material fixed on the sheet.

15. An image forming method, comprising:
measuring a temperature in a housing of an image forming apparatus; forming an image on a sheet with a photoconductive drum and a charging roller which are arranged in the housing;
determining whether or not the temperature meets a predetermined temperature;
controlling forming the image if it is determined that a determination result meets the predetermined temperature;
carrying out sheet passing control for a predetermined number of times;
determining whether or not the temperature in the housing meets the predetermined temperature;
if the determination result meets the predetermined temperature, carrying out the sheet passing control for the sheet; and
if the determination result does not meet the predetermined temperature, carrying out an image forming processing.

16. The image forming method according to claim 13, further comprising:
if the temperature in the image forming apparatus falls below the predetermined temperature, carrying out the sheet passing control.

17. An image forming method, comprising:
measuring a temperature in a housing of an image forming apparatus; forming an image on a sheet with a photoconductive drum and a charging roller which are arranged in the housing;
determining whether or not the temperature meets a predetermined temperature;
controlling forming the image if it is determined that a determination result meets the predetermined temperature; and
discharging the sheet in the sheet passing control without being subjected to the image forming processing.

18. The image forming method according to claim 11, wherein
measuring the temperature in the housing comprises measuring a temperature of the surface of the photoconductive drum.

19. The image forming method according to claim 11, wherein
measuring the temperature in the housing comprises measuring a temperature of a surface of the charging roller.

20. The image forming method according to claim 11, wherein
measuring the temperature comprises measuring with a non-contact thermometer.
